(19) United States
(12) Patent Application Publication
(10) Pub. No.: US 2024/0414586 A1
(43) Pub. Date: Dec. 12, 2024

(54) Enhanced QoS Support for Extended Reality (XR)

(71) Applicant: Apple Inc., CUPERTINO, CA (US)

(72) Inventors: Weidong YANG, San Diego, CA (US); Dawei ZHANG, Saratoga, CA (US); Haijing HU, Los Gatos, CA (US); Pavan NUGGEHALLI, San Carlos, CA (US); Ralf ROSSBACH, Munich (DE); Shu GUO, Beijing (CN); Sudeep MANITHARA VAMANAN, Uttenreuth (DE); Vivek G GUPTA, San Jose, CA (US); Wei ZENG, Saratoga, CA (US); Huarui LIANG, Beijing (CN)

(21) Appl. No.: 18/699,784

(22) PCT Filed: Oct. 11, 2021
(86) PCT No.: PCT/CN2021/123142

§ 371 Date: Apr. 9, 2024

(51) Int. Cl. H04W 28/02; G06T 19/00; H04L 67/12

(52) U.S. Cl. CPC H04W 28/0268; G06T 19/006; H04L 67/12

(57) ABSTRACT

A user plane function (UPF) of a core network is configured to receive an Internet Protocol (IP) packet including a flow label comprising a plurality of sub-fields, the plurality of sub-fields including an application data unit (ADU) identifier (ID) field for an ADU to which the IP packet belongs, map the IP packet to a quality of service (QOS) flow based on the flow label and transmit the IP packet to a base station with a tag including information from the plurality of sub-fields, the information including an ADU ID.

### BACKGROUND

A user equipment (UE) may establish a connection to at least one of a plurality of different networks or types of networks, for example a 5G New Radio (NR) radio access technology (RAT). The UE may access external data networks (DN), such as extended reality (XR) services, via the 5G NR radio access network (RAN) and 5G-Core (5GC). During operation, XR services may utilize multiple data flows in the uplink (UL) and/or downlink (DL). For example, in the DL, there may be a video stream, an audio stream and/or other data streams and, in the UL, there may be a control stream, a pose stream and/or other data streams.

Some XR applications require a minimum granularity of application data to be available at a client device (e.g., UE) before the client can begin to process the data. For example, all bits of a given video frame, all bits of a slice of a given video frame, or some percentage of those bits, may be required to be available before the video frame is processed by the UE. This minimum granularity of information required by a given application may be referred to as an Application Data Unit (ADU).

The entities involved in packet handling for XR traffic over the 5G NR RAT may include the UE, the 5G NR RAN (via a base station e.g., a next generation Node B (gNB)), and a user plane function (UPF) in the 5GC. To effectively process the IP packets for an XR service, these entities should know information for the ADU, e.g., to which ADU a given packet belongs. However, when end-to-end encryption is used for the transmission of IP packets, it may be difficult for these entities, particularly the base station and the UPF, to extract traffic-related information for the packet, including ADU membership information.

### SUMMARY

Some exemplary embodiments are related to a user plane function (UPF) of a core network configured to perform operations. The operations include receiving an Internet Protocol (IP) packet including a flow label comprising a plurality of sub-fields, the plurality of sub-fields including an application data unit (ADU) identifier (ID) field for an ADU to which the IP packet belongs, mapping the IP packet to a quality of service (QOS) flow based on the flow label and transmitting the IP packet to a base station with a tag including information from the plurality of sub-fields, the information including an ADU ID.

Other exemplary embodiments are related to a processor of a base station configured to perform operations. The operations include receiving an Internet Protocol (IP) packet including a tag indicating information including an ADU ID for an ADU to which the IP packet belongs, extracting the information indicated in the tag and performing downlink (DL) scheduling for a user equipment (UE) based on the information extracted from the tag.

Still further exemplary embodiments are related to a processor of a user equipment (UE) configured to perform operations. The operations include generating an Internet Protocol (IP) packet including a flow label comprising a plurality of sub-fields, the plurality of sub-fields including an application data unit (ADU) identifier (ID) field for an ADU to which the IP packet belongs and transmitting the IP packet with the flow label to a base station.

### BRIEF DESCRIPTION OF THE DRAWINGS

FIG. 1 shows an exemplary network arrangement according to various exemplary embodiments.

FIG. 2 shows an exemplary user equipment (UE) according to various exemplary embodiments.

FIG. 3 shows an exemplary base station according to various exemplary embodiments.

FIG. 4 shows an exemplary traffic flow diagram for XR application traffic according to various embodiments described herein.

FIG. 5 shows an exemplary network arrangement for QoS flow and DRB mapping according to various exemplary embodiments described herein.

FIG. 6a shows an exemplary flow label field including sub-fields for identifying packet information according to a first exemplary embodiment.

FIG. 6b shows an exemplary flow label field including sub-fields for identifying packet information according to a second exemplary embodiment.

FIG. 6c shows an exemplary unstructured flow label field according to a third exemplary embodiment.

FIG. 6d shows an exemplary traffic flow diagram for IP packets transmitted under a first or second flow label.

FIG. 7a shows an exemplary network arrangement for packet handling according to various exemplary embodiments described herein.

FIG. 7b shows the exemplary network arrangement for packet handling of FIG. 7a with exemplary pathways for configuring the packet handling of the network entities.

FIG. 7c shows the exemplary network arrangement for packet handling of FIG. 7a with exemplary downlink (DL) data flows.

FIG. 7d shows the exemplary network arrangement for packet handling of FIG. 7a with exemplary uplink (UL) packet flows.

### DETAILED DESCRIPTION

The exemplary embodiments may be further understood with reference to the following description and the related appended drawings, wherein like elements are provided with the same reference numerals. The exemplary embodiments relate to operations for providing packet-specific traffic information to network entities involved in the packet handling of Internet Protocol (IP) data traffic for services such as extended reality (XR).

Some XR services (and/or other services such as cloud gaming) may require some minimum granularity of data, referred to as an application data unit (ADU), to be available at a client device before the client device can begin to process the data. Thus, packet information regarding membership in a particular ADU may be useful for the entities involved in the handling of the packet. However, when end-to-end encryption is used, extracting traffic-related information for a packet may be difficult.

According to some exemplary embodiments, a packet filter is described including a modified “flow label” field for indicating ADU-related information for an IP packet. The flow label may be designed to include rich traffic information in a plurality of sub-fields, including parameters for helping a network entity to determine information about the packet, e.g., to which ADU the packet belongs, Qos flow information for the packet, whether received packets for a particular ADU should be discarded or forwarded, etc. The traffic information may be extracted by one network entity, e.g., the user plane function (UPF) of the 5G-Core (5GC) and preserved by attaching a tag when the packets are forwarded to the 5G RAN. This information may be further preserved in transmissions from the 5G RAN (e.g., gNB) to the UE.

According to further exemplary embodiments, operations are described for configuring the network entities for packet handling, for example configuring the UPF with packet detection rules (PDR), the gNB with a QoS profile and the UE with QoS rules in accordance with the ADU-indication framework described herein. The UPF, gNB and UE may then perform packet handling on the DL and/or the UL in accordance with the network configuration.

The exemplary embodiments are described with regard to extended Reality (XR). Those skilled in the art will understand that XR is an umbrella term for different types of realities and may generally refer to real-and-virtual combined environments and associated human-machine interactions generated by computer technology and wearables. To provide some examples, the term XR may encompass augmented reality (AR), mixed reality (MR) and virtual reality (VR). However, any reference to XR being specific to a particular use case or type of traffic is merely provided for illustrative purposes. Although the exemplary embodiments are described with regard to providing enhancements for XR services, the exemplary embodiments are not limited to XR services and may apply to any type of NR traffic that may be subject to ADU processing requirements imposed by an external application.

During operation, XR services may utilize multiple data flows in the uplink (UL) and/or downlink (DL). For example, in the DL, there may be a video stream, an audio stream and/or other data streams and, in the UL, there may be a control stream, a pose stream and/or other data streams. From a physical channel perspective, there may be different control channels and shared channels for each stream or multiple streams may share a control channel and/or shared channel. In some configurations, each stream may have different quality of service (QOS) requirements (e.g., block error rate (BLER), latency requirements, etc.). Additionally, one UE may transmit data on the UL that is forwarded to another UE on the DL.

In addition, the exemplary embodiments are described with regard to a UE. Those skilled in the art will understand that the UE may be any type of electronic component that is configured to communicate via a network, e.g., mobile phones, tablet computers, desktop computers, smartphones, phablets, embedded devices, wearables, Internet of Things (IoT) devices, etc. With regard to XR, in some configurations, the UE may be paired with a wearable device (e.g., a head mounted display (HMD), AR glasses, etc.). In this type of configuration, the UE may communicate directly with the network and then relay data to the wearable device which presents the XR content to the user (e.g., AR, VR, MR, etc.). In other configurations, the UE may be a wearable device that communicates directly with the network and presents the XR content to the user. Therefore, the UE as described herein is used to represent any electronic component that directly communicates with the network.

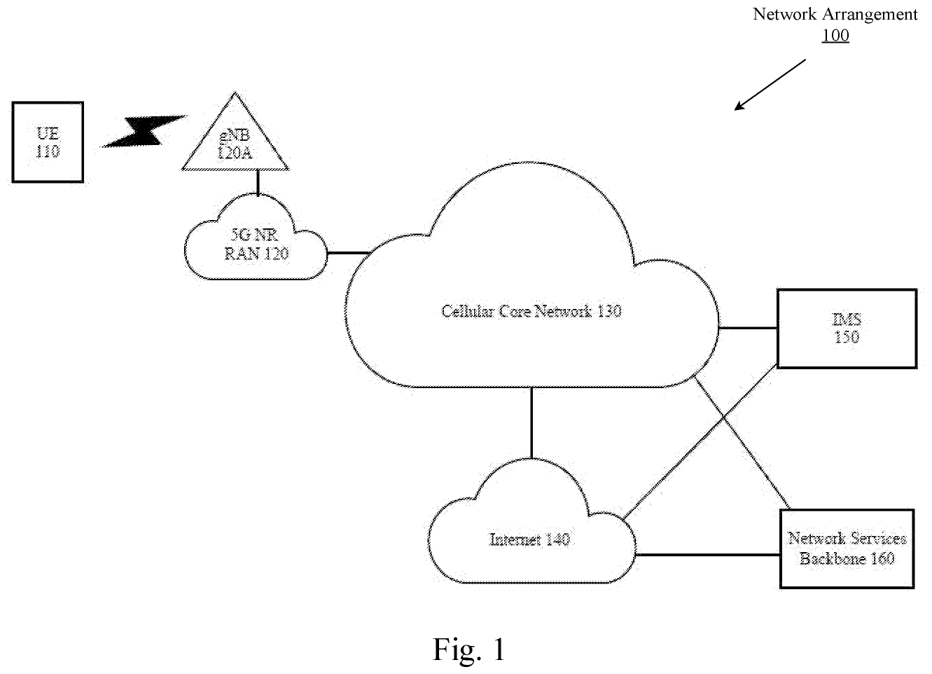

FIG. 1 shows an exemplary network arrangement 100 according to various exemplary embodiments. The exemplary network arrangement 100 includes a UE 110. Those skilled in the art will understand that the UE 110 may be any type of electronic component that is configured to communicate via a network, e.g., mobile phones, tablet computers, desktop computers, smartphones, phablets, embedded devices, wearables (e.g., HMD, AR glasses, etc.), Internet of Things (IoT) devices, etc. It should also be understood that an actual network arrangement may include any number of UEs being used by any number of users. Thus, the example of a single UE 110 is merely provided for illustrative purposes.

The UE 110 may be configured to communicate with one or more networks. In the example of the network configuration 100, the network with which the UE 110 may wirelessly communicate is a 5G NR radio access network (RAN) 120. However, the UE 110 may also communicate with other types of networks (e.g., 5G cloud RAN, a next generation RAN (NG-RAN), a long term evolution (LTE) RAN, a legacy cellular network, a WLAN, etc.) and the UE 110 may also communicate with networks over a wired connection. With regard to the exemplary embodiments, the UE 110 may establish a connection with the 5G NR RAN 120. Therefore, the UE 110 may have a 5G NR chipset to communicate with the NR RAN 120.

The 5G NR RAN 120 may be a portion of a cellular network that may be deployed by a network carrier (e.g., Verizon, AT&T, T-Mobile, etc.). The 5G NR RAN 120 may include, for example, cells or base stations (Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set.

The UE 110 may connect to the 5G NR-RAN 120 via the gNB 120A. Those skilled in the art will understand that any association procedure may be performed for the UE 110 to connect to the 5G NR-RAN 120. For example, as discussed above, the 5G NR-RAN 120 may be associated with a particular cellular provider where the UE 110 and/or the user thereof has a contract and credential information (e.g., stored on a SIM card). Upon detecting the presence of the 5G NR-RAN 120, the UE 110 may transmit the corresponding credential information to associate with the 5G NR-RAN 120. More specifically, the UE 110 may associate with a specific base station (e.g., gNB 120A). However, as mentioned above, reference to the 5G NR-RAN 120 is merely for illustrative purposes and any appropriate type of RAN may be used.

The network arrangement 100 also includes a cellular core network 130, the Internet 140, an IP Multimedia Subsystem (IMS) 150, and a network services backbone 160. The cellular core network 130 may be considered to be the interconnected set of components that manages the operation and traffic of the cellular network. The cellular core network 130 also manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

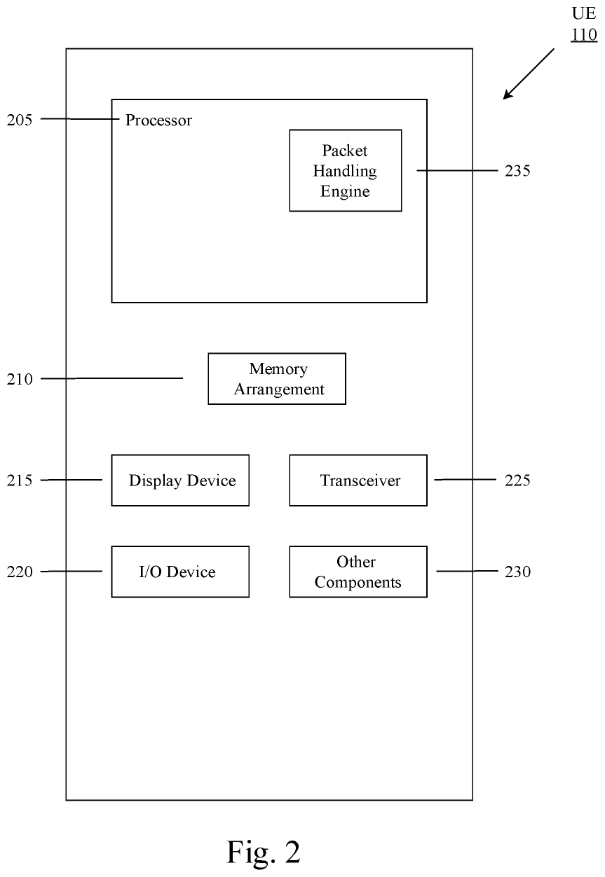

FIG. 2 shows an exemplary UE 110 according to various exemplary embodiments. The UE 110 will be described with regard to the network arrangement 100 of FIG. 1. The UE 110 may include a processor 205, a memory arrangement 210, a display device 215, an input/output (I/O) device 220, a transceiver 225 and other components 230. The other components 230 may include, for example, an audio input device, an audio output device, a power supply, a data acquisition device, ports to electrically connect the UE 110 to other electronic devices, etc.

The processor 205 may be configured to execute a plurality of engines of the UE 110. For example, the engines may include a packet handling engine 235 for performing various operations related to the exemplary ADU traffic flow arrangement described herein, to be described in detail below.

The above referenced engine 235 being an application (e.g., a program) executed by the processor 205 is merely provided for illustrative purposes. The functionality associated with the engine 235 may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 205 is split among two or more processors such as a baseband processor and an applications processor. The exemplary embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen. The transceiver 225 may be a hardware component configured to establish a connection with the 5G NR-RAN 120 and/or any other appropriate type of network. Accordingly, the transceiver 225 may operate on a variety of different frequencies or channels (e.g., set of consecutive frequencies).

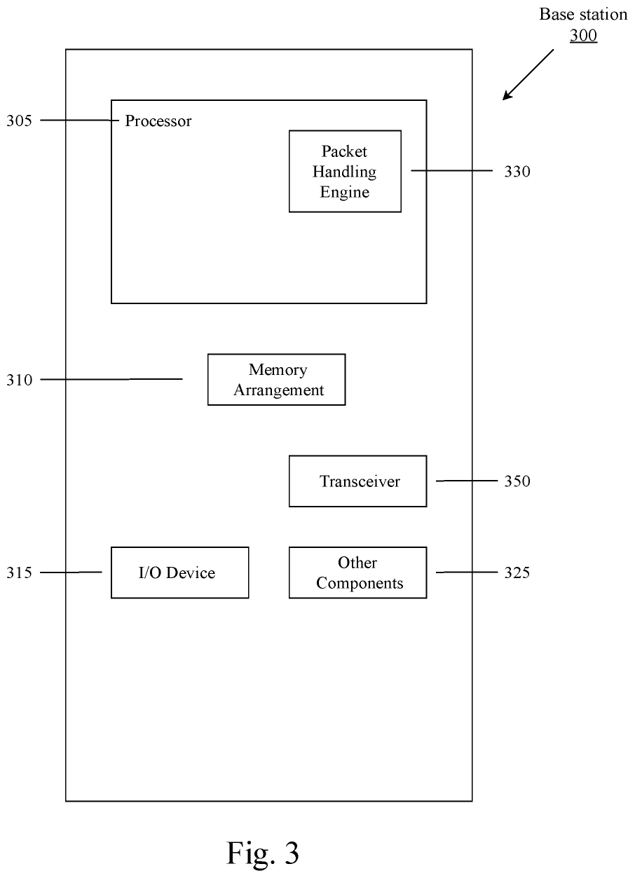

FIG. 3 shows an exemplary base station 300 according to various exemplary embodiments. The base station 300 may represent any access node (e.g., gNB 120A, etc.) through which the UE 110 may establish a connection and manage network operations.

The base station 300 may include a processor 305, a memory arrangement 310, an input/output (I/O) device 315, a transceiver 320, and other components 325. The other components 325 may include, for example, a battery, a data acquisition device, ports to electrically connect the base station 300 to other electronic devices, etc.

The processor 305 may be configured to execute a plurality of engines of the base station 300. For example, the engines may include a packet handling engine 330. The packet handling engine 330 may perform various operations related to the exemplary ADU traffic flow arrangement described herein, to be described in detail below.

The above noted engine 330 being an application (e.g., a program) executed by the processor 305 is only exemplary. The functionality associated with the engine 330 may also be represented as a separate incorporated component of the base station 300 or may be a modular component coupled to the base station 300, e.g., an integrated circuit with or without firmware. For example, the integrated circuit may include input circuitry to receive signals and processing circuitry to process the signals and other information. In addition, in some base stations, the functionality described for the processor 305 is split among a plurality of processors (e.g., a baseband processor, an applications processor, etc.). The exemplary embodiments may be implemented in any of these or other configurations of a base station.

The memory 310 may be a hardware component configured to store data related to operations performed by the base station 300. The I/O device 315 may be a hardware component or ports that enable a user to interact with the base station 300. The transceiver 320 may be a hardware component configured to exchange data with the UE 110 and any other UE in the system 100. The transceiver 320 may operate on a variety of different frequencies or channels (e.g., set of consecutive frequencies). Therefore, the transceiver 320 may include one or more components (e.g., radios) to enable the data exchange with the various networks and UEs.

In XR (and/or cloud gaming), application traffic on the downlink (DL) may comprise encoded video or scene information. Some XR applications may require a minimum granularity of application data to be available on the client side prior to performing the next level of processing. For example, in some configurations, client processing of application data may begin only once all bits of a video frame, or a certain percentage of those bits, are available to the client device. This application data may be, for example, a video frame that may be packetized into multiple IP payloads.

The minimum granularity of traffic consumption on the application client side may require some minimum set of IP packets to be available before the next level of processing begins. This minimum granularity of information required by a given application may be referred to as an “Application Data Unit” (ADU). XR (and/or cloud gaming) traffic comprises bursts of traffic that can carry one or more ADUs. Each ADU can consist of a number of IP packets, e.g., 3 or 4 IP packets. The number of IP packets included in an ADU may vary within a given application and across different applications depending on the data included therein. Thus, depending on the XR application, the size of the ADUs may be different. It should be understood that three or four IP packets is an example and the ADU may include any number of IP packets.

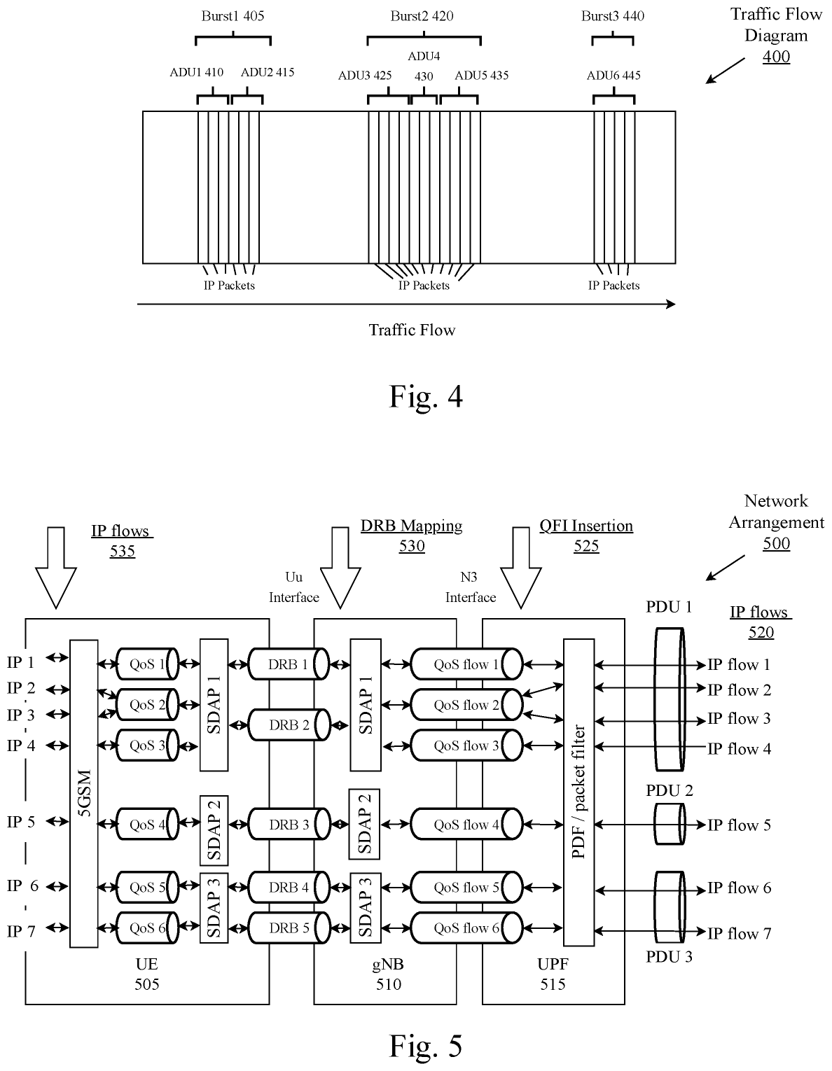

FIG. 4 shows an exemplary traffic flow diagram 400 for XR application traffic according to various embodiments described herein. The traffic flow 400 consists of a first burst (Burst1) 405 followed by a second burst (Burst2) 420 and a third burst (Burst3) 440 of IP traffic. In this example, the first burst 405 comprises a first ADU (ADU1) 410 and a second ADU (ADU2) 415, the second burst 420 comprises a third ADU (ADU3) 425, a fourth ADU (ADU4) 430 and a fifth ADU (ADU5) 435, and the third burst 440 comprises a sixth ADU (ADU6) 445. In this example, ADUs 1, 2 and 4 comprise three IP packets, while ADUs 3, 5 and 6 comprise four IP packets. The IP packets belonging to a particular ADU may be transmitted across multiple data streams or in the same data stream.

When end-to-end encryption is used for the transmission of a given IP packet it may be difficult to extract traffic-related information for the packet. For example, when IPSec tunneling or web real-time communication (webRTC) protocols are used, traffic-related information may be hidden from a network entity involved in packet handling, e.g., the UPF or the gNB.

Some video compression standards utilize different algorithms called “picture types” for compressing video frames, e.g., picture types I, P and B for generating I-frames, P-frames and B-frames, respectively. An I-frame is the least compressible and contains an entire image, a P-frame is more compressible than an I-frame, but to decompress an I-frame requires some decoding of previous frames, and a B-frame is the most compressible, but to decompress a B-frame requires some decoding of previous frames and subsequent frames. High efficiency video coding (HEVC) (e.g., H.265) and advanced video coding (AVC) (e.g., H.264) refer to two video compression standards providing high video quality at low bit rates. In these standards, the granularity of the picture types is reduced to the “slice” level, wherein a slice (e.g., I-slice, P-slice or B-slice) refers to a region of a video frame encoded separately from the remainder of the frame.

The network abstraction layer (NAL) is part of the AVC/HEVC standards and defines the encapsulation of the coded video data for transportation and storage. When HEVC or AVC over RTP is used for video frame compression, the NAL-layer packet may be carried over an RTP packet or a dynamic adaptive streaming over HTTP (DASH) packet. Traffic-related information for the encapsulated IP packet, e.g., whether I-slices and/or P-slices are carried in the IP packet, which may be indicated in the NAL layer, may not be visible to the user plane function (UPF) or the gNB as the NAL layer packet is carried over an RTP packet or a DASH packet. For example, for webRTC, secure RTP (SRTP) is used for the transmission of the IP packets. The payload of a SRTP packet, which contains the traffic related information, is not visible to the UPF/gNB.

According to various exemplary embodiments, operations are described for providing packet-specific traffic information to network entities involved in the packet handling of Internet Protocol (IP) data traffic. Specifically, solutions are described for providing relevant packet information to the 5GC and the 5G RAN regarding an application data unit (ADU) to which the packet belongs when the packets are encrypted/encapsulated by protocols such as HEVC or AVC. The solutions described herein relate to the identification of which packets belong to the same ADU and how the information regarding the association of a packet with an ADU is extracted, used, and retained from one network node to another.

The 5G-RAN and 5GC ensure quality of service (Qos) by mapping packets to appropriate QoS flows and DRBs. The entities involved in packet handling of downlink (DL) data and uplink (UL) data for a UE generally include a user plane function (UPF) of the 5GC (e.g., an instance of the UPF), a base station (gNB) and the UE. Each of these entities identifies certain information about the packet prior to processing the packet.

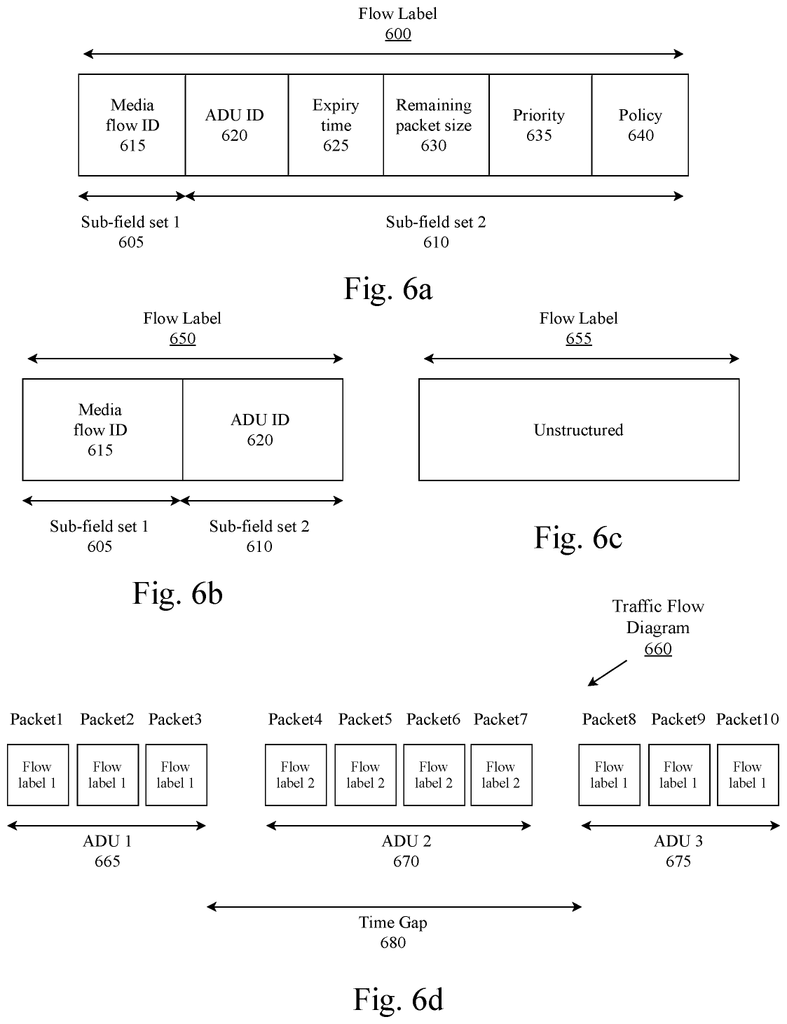

FIG. 5 shows an exemplary network arrangement 500 for QoS flow and DRB mapping according to various exemplary embodiments described herein. The network arrangement 500 includes a UE 505, a gNB 510 and a UPF 515. The QoS flow and DRB mapping is described herein for a downlink traffic flow comprising multiple data streams. However, the person skilled in the art understands that a similar and complementary process may also occur on the uplink.

In a first step for DL packet handling, at the non-access stratum (NAS) level, the UPF 515 receives IP data flows 520 via one or more PDU sessions. Each PDU session may correspond to a connection with a different data network (DN) and/or the Internet. In the example of FIG. 5, the UPF 515 receives a first IP flow (IP1), a second IP flow (IP2), a third IP flow (IP3) and a fourth IP flow (IP4) via a first set of PDU sessions (PDU 1). The first set of PDU sessions may comprise, for example, Internet PDU sessions, and the IP flows 1-4 may correspond to video streams, e.g., YouTube or Skype video streams. The UPF 515 receives a fifth IP flow (IP5) via a second set of PDU sessions (PDU 2), e.g., a streaming service PDU session, and IP5 may correspond to a video stream, e.g., a Netflix stream. The UPF 515 receives a sixth IP flow (IP6) and a seventh IP flow (IP7) via a third set of PDU sessions (PDU 3). The third set of PDU sessions may comprise, for example, IMS PDU sessions, wherein IP6 corresponds to a voice stream and IP7 corresponds to a video stream. It should be understood that each of these streams is only exemplary and the streams are not limited to any specific type of stream.

The UPF 515 processes the received packets using a Service Data Flow (SDF) traffic filter template, e.g., a packet filter, to be explained in further detail below. The UPF 515 maps the IP flows to Qos flows based on packet detection rules (PDR) configured by the 5GC. The UPF 515 associates a QoS flow identifier (QFI) with the IP flows by inserting a QFI into the packets (step 525) and transmitting the packets to the gNB 510 over the N3 interface via e.g., a GTP-U tunnel. In the example of FIG. 5, IP1 maps to a first QoS flow (QFI=1), IP2 and IP3 map to a second QoS flow (QFI=2), IP4 maps to a third QoS flow (OFI=3), IP5 maps to a fourth Qos flow (QFI=4), IP6 maps to a fifth QOS flow (QFI=5), and IP7 maps to a sixth Qos flow (QFI=6).

In a second step, at the AS level, the gNB 510 receives the QoS flows from the UPF 515 via N3 and maps the QoS flows to DRBs via one or more instances of the SDAP layer based on QoS profiles configured by the network. The DRB defines the packet treatment on the radio interface (Uu) and serves packets with the same packet forwarding treatment. The QoS flow to DRB mapping by the gNB 510 is based on QFI and the associated QoS profiles (i.e., QoS parameters and QoS characteristics) configured by the 5GC. The QoS profiles for the respective OFIs are provided by the AMF to the 5G-RAN (gNB 510), to be described in further detail below.

Separate DRBs may be established for QoS flows requiring different packet forwarding treatment, or several Qos flows belonging to the same PDU session can be multiplexed in the same DRB. The gNB 510 associates a DRB ID with the QoS flows and transmits the packets to the UE 505 over the air interface (Uu). In the example of FIG. 5, the first QoS flow maps to a first DRB (DRB=1), the second and third QoS flows map to a second DRB (DRB=2), the fourth QoS flow maps to a third DRB (DRB=3), the fifth QoS flow maps to a fourth DRB (DRB-4), and the sixth QoS flow maps to a fifth DRB (DRB=5).

In a third step, at the UE level, the UE 505 receives the data in the DRBs over the air interface via one or more instances of the SDAP layer. The QoS flows are mapped by the 5GSM layer to IP flows according to packet filters contained in Qos rules configured by the 5GC, to be explained in further detail below. The PDRs at the UPF 515 and the QOS rules at the UE 505 may include similar and complementary packet filters. Thus, the original IP packets are extracted and delivered to the higher layers. It should be understood that when IP flows are generated by the UE 505 for UL transmission, the 5GSM layer similarly maps IP flows to Qos flows according to the packet filters contained in the QoS rules

The QoS flow and DRB mapping for a traffic flow (DL or UL) is subject to the following rules in the 5G system. First, a DRB on the air interface (Uu) can have a one-to-many relationship with a GTP-U tunnel on the N3 interface at the UPF. Second, each QoS flow is mapped to a single GTP-U tunnel at the N3 interface. Third, a gNB may map individual QoS flows to one or more DRBs. Fourth, a PDU session may contain multiple QoS flows and several DRBs, but only a single N3 GTP-U tunnel. Fifth, a DRB may transport one or more QOS flows. Sixth, the QFI that identifies the QoS flow is carried in an extension header on N3 in the GTP-U protocol, using DL and UL PDU session information frames. Seventh, the DL and UL PDU session information frame includes a QOS Flow Identifier (QFI) field for each packet. Eighth, the DL PDU session information frame includes the Reflective QOS Indicator (ROI) field to indicate whether the user plane reflective Qos is to be activated or not. This is applicable only if reflective Qos is activated.

In addition to the above rules, DL traffic flows are subject to the following additional rules. First, incoming IP packets are classified by the UPF according to a packet detection rule (PDR) which includes a packet filter set. Second, the QFI is inserted into the inspected packet and the marked packet is sent by the UPF to the gNB through the N3 interface. Third, DRB mapping is conducted at the gNB side.

A packet filter set is specified in the Third Generation Partnership (3GPP) standard TS 23.501 and may be used for the UPF marking/classification of packets. A traffic flow template may include a 20-bit “flow label” that can be used for identifying a packet filter component. According to current behavior, all 20 bits in the “flow label” are used for marking, and a partial match is not supported. One application of a packet filter is shown in TS 38.523-01. According to this specification, a fixed value for the “flow label” is assumed.

According to certain exemplary embodiments, a packet filter is described as including a modified “flow label” field that includes sub-fields for identifying packet information such as an ADU to which the packet belongs. The sub-fields may include one or more of a media flow identifier field, an ADU identifier field, an expiry time field, a priority field, a remaining packet size field and a policy field, to be described in detail below. In one embodiment, all of these sub-fields are used to provide a high degree of granularity for the packet information. However, the inclusion of this number of sub-fields necessarily increases the complexity of the ADU-indication architecture. In other embodiments, fewer sub-fields may be used.

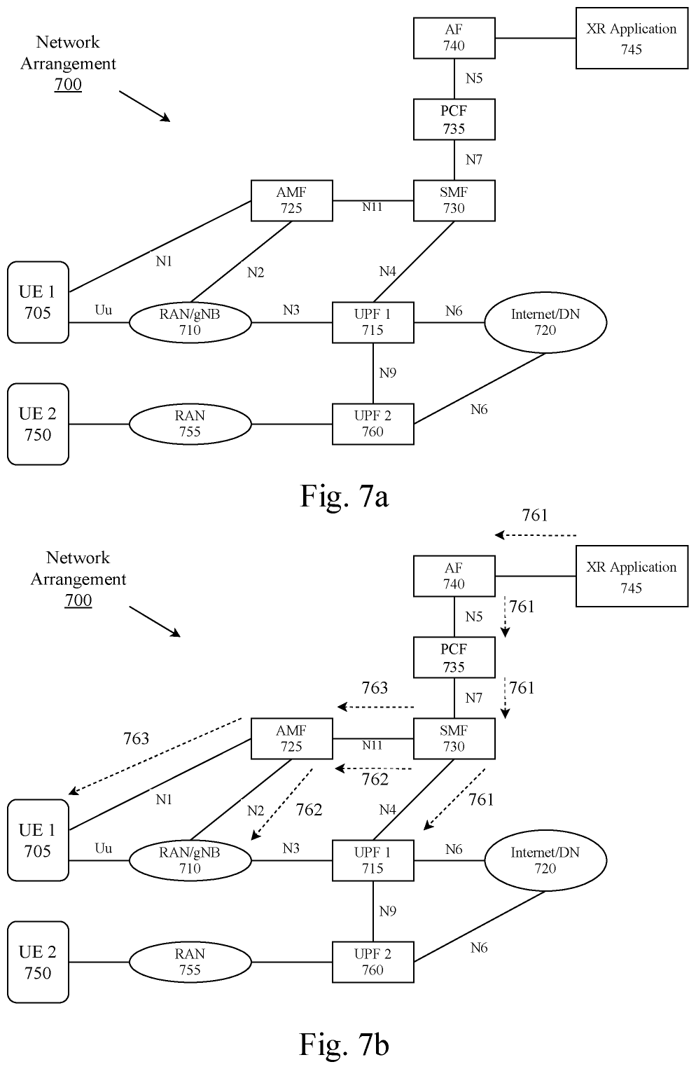

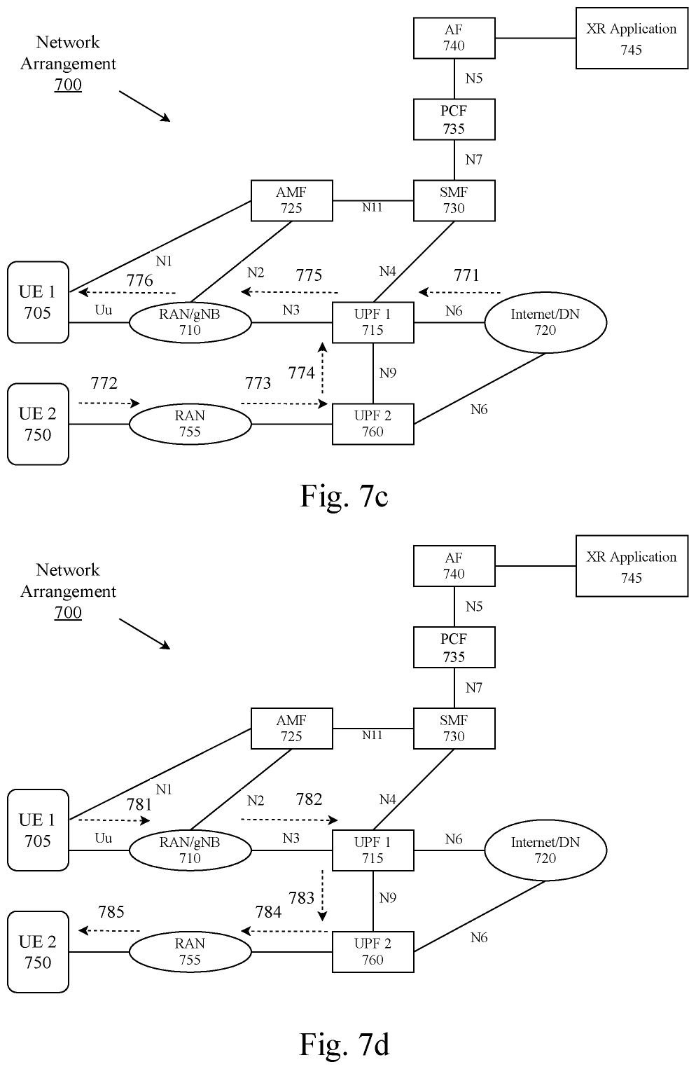

FIG. 6a shows an exemplary flow label field 600 including sub-fields 615-640 for identifying packet information according to a first exemplary embodiment. The sub-fields are subdivided into a first set of sub-fields 605, including only a media flow identifier field 615, and a second set of sub-fields 610, including an ADU identifier field 620, an expiry time field 625, a priority field 630, a remaining packet size field 635 and a policy field 640. The first set of sub-fields 605 and the second set of sub-fields 610 may be subject to different processing operations, to be described in further detail below with respect to FIGS. 7c-d. As discussed above, the flow label field according to current specification comprises 20 bits. The following provides a description of the sub-fields including exemplary sizes in the number of bits. It should be understood the sizes are exemplary and other sizes may be used depending on the specific implementation of the exemplary embodiments.

The media flow ID field 615 may correspond to a currently specified “flow identifier” field for identifying a type of IP flow and an associated destination IP address/port number (see TS 29.207). The media flow ID field 615 may comprise e.g., 10 bits. Irrespective of the specification details, the “flow identifier” from TS 29.207 cannot provide the granularity for identifying packets within an ADU. The media flow ID field 615 may be considered “permanent” in the sense that its values do not change from packet to packet.

The ADU ID field 620 may indicate an ADU to which the packet belongs, e.g., 1, 2, 3, 4, etc. In some embodiments, the ADU ID field 620 may comprise 2 bits. However, a greater number of bits may be used for identifying a greater number of different ADUs.

The expiry time field 625 may indicate a duration of time to wait to receive all the packets of the identified ADU. For example, if the gNB does not receive all of the packets of the ADU within the time span beginning at the receipt of the first packet of the ADU and ending after the duration of the indicated expiry time, then the gNB can discard all of the packets received for the identified ADU. In some embodiments, the expiry time field 625 may comprise 2 bits for indicating four different possible expiry time durations. However, a greater number of bits may be used to achieve a finer granularity for the expiry time indication.

The remaining packet size field 635 may indicate a number of bytes remaining for transmission for the identified ADU. In some embodiments, the remaining packet size may be indicated in a unit such as 16 bytes, 32 bytes, etc. In combination with the expiry time field 625, the remaining packet size field 630 may be used to help the gNB decide whether to discard all the packets received for a given ADU. In some embodiments, the remaining packet size field 630 may comprise 2 bits. However, a greater number of bits may be used to achieve a finer granularity for the remaining packet size indication.

The priority field 630 may indicate a type of media in the packet so that preferential treatment may be given to certain types of media in the identified ADU. For example, when high efficiency video coding (HEVC) (e.g., H.265) or advanced video coding (AVC) (e.g., H.264) over RTP is used, the priority field 630 may indicate whether an I-slice or a P-slice (or both) are carried in the packet. Thus, the priority field 630 in combination with the ADU ID field 620 may indicate the type of media belonging to a particular ADU. This information may be used to, for example, map certain types of media to certain Qos flows. In some embodiments, the priority field 630 may comprise 1 bit. However, a greater number of bits may be used for identifying a greater number of different types of media with associated priorities.

The policy field 640 may indicate a policy for the treatment of bits within the identified ADU. For example, a first policy may state a certain percentage of IP packets in the ADU, e.g., 25% or 50% of contiguous IP packets, have to be received correctly for the packets to be useful. A second policy may indicate a group of picture (GOP) pattern, e.g., an I-slice followed by three P-slices (IPPP). In some embodiments, the policy field 640 may comprise 2 bits. However, a greater number of bits may be used for identifying a greater number of different policies.

As discussed above, the exemplary flow label field 600 may be used to identify an ADU membership and a media flow for an IP packet. One or more of the sub-fields, e.g., the media flow ID field 605 or the priority field 630, may be used to map a packet to a QoS flow. One or more of the sub-fields, e.g., the ADU ID 615, may be mapped to new fields in the N3 encapsulation header for the packet prior to transmission from the UPF to the gNB. In one example, the media flow ID, the ADU ID, the remaining size, the policy and the priority may be mapped to new fields in the N3 encapsulation header. In another example, the ADU ID, the remaining size, the policy and the priority may be mapped to the new fields in the N3 encapsulation header, and the media flow ID may be omitted.

According to other embodiments, a packet filter is described including a flow label indicating a reduced set of information relative to the embodiments described above. Instead of providing very rich traffic information, as described above, only an ADU membership parameter may be indicated.

FIG. 6b shows an exemplary flow label field 650 including sub-fields 615-620 for identifying packet information according to a second exemplary embodiment. Similar to the embodiment described above, the sub-fields are subdivided into a first set of sub-fields 605 and a second set of sub-fields 610. In the example of FIG. 6b, the first set 605 includes only the media flow identifier field 615 and the second set 610 includes only the ADU identifier field 620. The media flow ID field 615 and the ADU identifier field 620 may be configured similarly to those described for the flow label 600 of FIG. 6a.

In a still further embodiment, a packet filter is described including a flow label that is unstructured and thus does not directly indicate any information regarding ADU membership of the associated packet, similar to the currently specified flow label for a packet filter. FIG. 6c shows an exemplary unstructured flow label field 655 according to a third exemplary embodiment.

In the third embodiment, two packet filters are configured for the UPF (by a session management function (SMF)), e.g., a first packet filter for a first flow label and a second packet filter for a second flow label. This embodiment may be used in a simple case of packet transmission where in-order delivery of IP packets at the UPF is assumed (for both DL and UL. IP packets belonging to the same ADU may be transmitted under the same flow label, wherein the UPF maps the IP packets under the same flow label to the same QoS flow. For example, IP packets of a first ADU may be transmitted under flow label 1, and IP packets of a second ADU following the first ADU may be transmitted under flow label 2. IP packets of a third ADU will then be transmitted under flow label 1, etc. Thus, the flow labels are alternated for in-order ADUs in a “ping-pong” scheme.

FIG. 6d shows an exemplary traffic flow diagram 660 for IP packets transmitted under a first or second flow label. The traffic flow 660 comprises IP packets belonging to a first ADU (ADU 1) 665, a second ADU (ADU 2) 670 and a third ADU (ADU 3) 675. The first transmission is ADU 1 665 comprising three packets transmitted under a first flow label (flow label 1), followed by ADU 2 670 comprising four packets transmitted under a second flow label (flow label 2), followed by ADU 3 675 comprising three packets transmitted under flow label 1.

To avoid possible confusion regarding whether IP packets transmitted under the same flow label belong to the same ADU, a time gap 680 may be imposed between packets from different ADUs mapped to the same QoS flow.

In other embodiments, more flow labels may be used to avoid this ambiguity. In this embodiment, QFI itself turns into a quasi-ADU index. Less processing is needed, as there is no additional traffic information to include in further transmissions of the IP packets, for example in tags to be described in further detail below. However, for this embodiment to work effectively, the number of required QoS flows may be large.

FIG. 7a shows an exemplary network arrangement 700 for packet handling according to various exemplary embodiments described herein. Similar to the arrangement 500 described above in FIG. 5, the network arrangement 700 includes those entities directly involved in packet handling for a UE, e.g., the UE itself, the 5G RAN (gNB), and the UPF. Additionally, further entities are included that are involved in the configuration of the packet handling entities (e.g., further aspects of the 5GC) and/or the UL/DL traffic flows for the UE (e.g., further UEs), to be described in detail below.

Throughout this description, various components are shown and described as being connected via connections labeled Nx (e.g., N1, N2, N11). Those skilled in the art will understand that each of these connections (or interfaces) are defined in the 3GPP Specifications. Thus, when these connections are described herein, they are being used as defined in the 3GPP Specifications.

The exemplary network arrangement 700 includes a first UE (UE 1) 705 accessing a data network (DN) 720, e.g., a DN for an XR service, via a gNB 710 of the 5G RAN and a first instance of the UPF (UPF 1) 715.

The UPF 1 715 acts as an external PDU session point of interconnect to DN 720 and may perform packet routing and forwarding, perform packet inspection, enforce the user plane part of policy rules, lawfully intercept packets (UP collection), perform traffic usage reporting, perform Qos handling for a user plane (e.g., packet filtering, gating, UL/DL rate enforcement), perform Uplink Traffic verification (e.g., SDF to QoS flow mapping), transport level packet marking in the uplink and downlink, and perform downlink packet buffering and downlink data notification triggering. The UPF 1 715 may include an uplink classifier to support routing traffic flows to the DN 720. The DN 720 may represent various network operator services, Internet access, or third party services such as XR services. The DN 720 may include, or be similar to, an application server (AS). The UPF 1 715 may interact with the SMF 730 via an N4 reference point between the SMF 730 and the UPF 1 715.

Additional network entities of the 5GC shown in the network arrangement 700 include an access and mobility management function (AMF) 725, a session management function (SMF) 730, a policy control function (PCF) 735 and an application function (AF) 740.

The AMF 725 is responsible for functions such as registration management and connection management. The AMF 725 may provide transport for session management (SM) messages between the UE 705 and the SMF 730, and act as a transparent proxy for routing SM messages. The AMF 725 communicates with the SMF 730 over the N11 interface and with the UE 705 over the N1 interface (e.g., NAS signaling). Furthermore, the AMF 725 may be a termination point of a CP interface for the RAN 710, which may include or be an N2 reference point between the RAN 710 and the AMF 725. The AMF 725 may also handle signaling over the N2 from the SMF 730 for PDU sessions and QoS.

The SMF 730 is responsible for session management (SM) (e.g., session establishment, modify and release). SM may refer to management of a PDU session, and a PDU session or “session” may refer to a PDU connectivity service that provides or enables the exchange of PDUs between the UE 1 705 and the data network (DN) 720. PDU sessions may be established upon UE request, modified upon UE or 5GC request, and released upon UE or 5GC request. Upon request from an application server (AS), the 5GC may trigger a specific application in the UE. In response to receipt of the trigger message, the UE may pass the trigger message (or relevant parts/information of the trigger message) to one or more identified applications in the UE. The identified application(s) in the UE may establish a PDU session to a specific DN. The SMF 730 may support interactions with external DNs for transport of signaling for PDU session authorization/authentication by the external DN.

The PCF 735 may provide policy rules to control plane function(s) and may also support unified policy frameworks to govern network behavior. The PCF may communicate with the AMF 725, the SMF 730 and the AF 440.

The AF 740 may provide application influence on traffic routing and interact with the policy framework for policy control. The AF 740 acts as a quality controller for specific applications residing on the network, and interconnects with the PCF 735.

The network arrangement 700 additionally includes a second UE (UE2) 750 accessing the DN 720 via a RAN 755 and a second instance of the UPF (UPF 2) 760. The RAN 755 may be the 5G RAN for a same public land mobile network (PLMN) or a different PLMN. As will be described in further detail below, the UE 2 750 may exchange IP packets with the UE1 705 that are subject to the same ADU-indication functionality described herein, for example when the UE 1 705 and the UE 2 are accessing a same XR service. The UPF 2 760 and the DN 720 communicate over the N6 interface.

FIG. 7b shows the exemplary network arrangement 700 for packet handling of FIG. 7a with exemplary pathways for configuring the packet handling of the network entities.

The first pathway 761 relates to a QoS configuration for the UPF 1 715. The UPF 1 715 is configured with one or more packet detection rules (PDR) by the SMF 730 via the N4 interface. The AF 740 receives information from the XR application 745 and forwards the information to the PCF 735 over the N5. The PCF 735 transmits a policy and charging control (PCC) rule to the SMF 730 over N7, which in turn configures the UPF 1 715 with the PDR(s).

As discussed above, the QoS configuration may include an association of QFI with IP flows. To be described in further detail below with respect to FIGS. 7c-d, the QoS configuration may include an indication of one or more packet filter compositions so that the UPF may process the IP flows based on the flow label field included in received IP packets. Additionally, the UPF 1 may tag the IP flows with traffic information included in the flow label based on the PDR.

The second pathway 762 relates to a configuration of a QoS profile for the gNB 710. The gNB 710 is configured with the QoS profile by the SMF 730 (via the AMF 725) via N2 signaling.

As discussed above, the QoS profile may include QoS parameters and QoS characteristics for mapping a QFI to a DRB. To be described in further detail below with respect to FIGS. 7c-d, the configuration may also include the extraction of data from the attached tags for performing ADU-aware scheduling.

The third pathway 763 relates to a configuration of Qos rules for the UE 705. The UE 705 is configured with the QoS rules by the SMF 730 (via the AMF 725) via N1 signaling. The Qos rules may include parameters for processing the received IP flows, also including a packet filter.

FIG. 7c shows the exemplary network arrangement 700 for packet handling of FIG. 7a with exemplary downlink (DL) data flows. In the following, a processing flow is described for DL data transmissions to a UE. The UPF 1 715 receives data on the DL from the DN 720 via the N6 interface (flow 771) or from the UPF 2 760 via the N9 interface (flow 774). The gNB 710 receives data on the DL from the UPF 1 715 via the N3 interface. The UE 705 receives data on the DL from the gNB 710 via the Uu interface.

IP packets to be received on the DL by the UE 1 705 may be generated at the DN 720, e.g., the XR server, by an XR application. In 771, the UPF 1 715 receives IP packets from the DN 720 over the N6. IP packets may also be generated at the UE 2 750 that is accessing the XR service at the same time as the UE 1 705. For example, the UE 1 705 and UE 2 750 may be participating together in an XR service. In 772, the UPF 1 receives IP packets from the UPF 2 760 of the UE 2 750. To be described in further detail below with respect to FIG. 7d, the UPF 2 760 receives the IP packets from the RAN 755 (flow 773), which receives the IP packets from UE 2 750 (flow 772).

The IP packets receives by the UPF 1 715 in 771, 772 are generated by the DN 720 and/or the UE 2 with a “flow label” field marked with sub-fields as described above. For example, the flow label may include a plurality of sub-fields including fine granularity ADU-related information, may include only a media flow identifier and an ADU identifier, or may include only an ADU identifier.

As mentioned above, the SMF 730 indicates the packet filter composition to the UPF 1 715, the packet filter composition including a source IP address and a destination IP address (set 1 of sub-fields of “flow label”) for marking (e.g., the first 10 bits). As discussed above, set 1 of the sub-fields is “permanent” in the sense that its values do not change from packet to packet. When the IP packets are routed to UPF 1 715, it is assumed that the “flow label” field in any IP packet is not modified by a router in route to the UPF 1 715.

In 775, the UPF 1 715 classifies the received IP packets into QOS flows and, for each received IP packet, attaches a tag (tag-1) composed from set 2 of the sub-fields of the “flow label,” along with OFI. The UPF 1 715 transmits the IP packets with attached tags over the N3 interface to the gNB 710.

The gNB 710 may include a CU-DU partition, or may not include a CU-DU partition. When the gNB 710 does not have a CU-DU partition, the encapsulated IP packets are received at the gNB 710 and, for each received packet, the tag (tag-1) is read. Based on the traffic information embedded in the tag, the gNB 710 can perform delay-sensitive/ADU-aware scheduling for the UE 1 705.

When the gNB 710 has a CU-DU partition, the encapsulated IP packets are received at the CU and transferred to the PDCP layer for transmission to the DU. For any PDCP packet sent down to the DU, a tag (tag-2) is attached to the packet that is inherited from tag-1. At the DU, delay-sensitive/ADU-aware scheduling is done with fine traffic information embedded in the tag (tag-2).

In 776, the gNB 710 transmits the encapsulated IP packets (e.g., SDAP/PDCP/RLC headers) via one or more DRBs to the UE 705. The UE 705 receives the IP packets and processes the packets based on the packet filters contained in the Qos rules.

FIG. 7d shows the exemplary network arrangement 700 for packet handling of FIG. 7a with exemplary uplink (UL) packet flows. In the following, a processing flow is described for UL data transmissions from a UE destined for another UE. The UE 1 705 transmits data on the UL to the gNB 710 via the Uu interface (flow 781). The gNB 710 transmits data on the UL to the UPF 1 715 via the N3 interface (flow 782). UPF 1 715 transmits data to the UPF 2 760 via the N9 interface (flow 783). UPF 2 760 forwards the data to the RAN 755, which forwards the data to the UE 2 750.

In 781, the UE 1 705 attaches a flow label to UL IP packets based on the packet filters contained in the Qos rules. The SMF 730 indicates the packet filter composition to the UE 1 705 and to the gNB 710, e.g., source IP address and destination IP address (set 1 of sub-fields of “flow label”) for marking. UE 1 705 generates IP packets with “flow label” marked with sub-fields according to the exemplary embodiments discussed above. The IP packets are put into queues for different DRBs, following the scheduling and/or configuration (SPS/configured grant/dynamic scheduling) from the gNB 710. The UPF 715 may check whether the UE 1 705 marks the outbound IP packets correctly, e.g., with respect to the flow label according to the packet filter(s) configured by the SMF 730.

UE 1 705 may additionally report ADU status to the gNB 710 in various ways to be described below, e.g., through PUCCH (new UCI feedback). New UCI types may be designed to support ADU compositions, including essentially the same types of “tag” information described above that is carried to the gNB 710 on the DL.

At the gNB 781, delay-sensitive/ADU-aware scheduling is done with fine traffic information embedded in the UCI. In 782, the gNB 710 transmits the traffic to the UPF 1 715, which forwards the traffic to the UPF 2 760. The “flow label” for each packet is not modified by the UPF 1 715 in case those packets eventually reach UE 2 750, in accordance with the configuration discussed above for DL traffic flows.

As mentioned above, the UE 1 705 may report some ADU status information to the gNB 710 to help the gNB 710 perform delay-sensitive and ADU-aware scheduling for further UL transmissions. The UE 1 705 is able to make some choices for UL transmissions according to e.g., specified logical channel prioritization rules, but many decisions with respect to UL transmissions are made on the gNB side.

In one option, the UE provides this information using UCI for ADU over the PUCCH. For each ADU, the UE may report a remaining packet size for the ADU, an expiry time, etc. The remaining packet size field may provide enhanced information relative to, for example, a BSR. To facilitate decoding by the gNB, a two part UCI feedback may be used, similar to two-part CSI feedback. A first part of the UCI may indicate a number of ADU reports, and a second part of the UCI may indicate the actual ADU reports.

With regard to a multiplexing order for the UCI feedback, the ADU-UCI may be prioritized over scheduling reports (SR) or channel state information (CSI), but may have a lower prioritization than HARQ-ACK feedback. The priority order may be denoted as (HARQ-ACK>ADU-UCI>SR>CSI).

In another option, the UE provides this information using a MAC-CE. A tag similar to “tag-1” discussed above may be used. However, if a MAC-CE feedback option is used, the processing latency may be an issue.

In still another option, a mechanism may be used that is similar to a PDCP control PDU, e.g., a PDCP control PDCU for interspersed ROHC feedback or for status report.

It is noted that no ADU status feedback is necessary for the scheduling of further DL transmissions.

It is further noted that the options discussed above are based on the specification of a “flow label” containing sub-fields, as discussed in FIGS. 6a-b. However, in case the “flow label” with sub-fields is not used, then the existing flow label may be used and marked according to existing specification. As mentioned above with respect to FIG. 7c, the SMF may configure two or more packet filters compositions to be used by the UPF to categorize the IP packets belonging to a same ADU under a same flow label (QOS flow).

Alternatively, the XR application may inform the AF/SMF about a marking scheme used by the XR application for generating IP packets. With this information, the SMF may customize the packet filter for the UPF.

To support marking and packet filters for ADU-aware/delay and reliability sensitive scheduling, the UPF needs to mark and filter packets according to the incoming packets from N6. New packet filter rules may be developed for IPSec/SRTP traffic wherein traffic information is extracted from the IP header. The SMF configures new packet filter rules to the UPF, and the UPF attaches tag to packets crossing the N3.

With the attached tags, the gNB performs ADU-aware/delay and reliability sensitive scheduling. The gNB may perform packet handling over the CU-DU (F1) interface so that the tag information can propagate to the DU.

So far, on the DL, the UE has been considered as the end point of DL data, and the XR client on the UE consumes the data. However, if the UE is used as a router or relay (sidelink connecting XR device with a UE with 5G modem), then new packet filters for DL may also be configured for the UE. For the UL, marking and packet filters for the UE also need to be updated.

To achieve application awareness at the RAN and 5GC, the following alternatives may be used. In a first alternative, the Application propagates QoS related configuration data for the UPF (Application->AF->PCF->SMF->UPF), the gNB (Application->AF->PCF->SMF (via AMF)->gNB), and the UE (Application->AF->PCF->SMF (via AMF)->UE).

In a second alternative, the UE may negotiate the QoS configurations with the application. In this way, RAN awareness and application awareness are achieved and maintained at the same time. The UE propagates QoS related configuration data for the UPF (UE (via AMF)->SMF->UPF), the gNB (UE (via AMF)->SMF (via AMF)->UPF), and the UE (UE (via AMF)->SMF (via AMF)->UE). The UE makes a recommendation for the QoS configurations, subject to SMF (and PCF) approval/modification.

To achieve RAN and 5GC awareness for the application, the following alternatives may be used. In a first alternative, the SMF propagates RAN/5GC information to the Application (SMF->PCF->AF->Application). In a second alternative, the UE propagates RAN/5GC information to the Application over a proprietary interface (UE->Application).

In the above description, it should be clear that the UE and the UPF may perform some corresponding operations. For example, the operations performed by the UPF in the DL may correspond to operations performed by the UE in the UL. Likewise, the operations performed by the UE in the DL may correspond to operations performed by the UPF in the UL.

### Examples

In a first example, user plane function (UPF) of a core network is configured to perform operations comprising receiving a quality of service (QOS) configuration from a session management function (SMF) for one or more packet detection rules (PDR), the PDRs comprising two or more packet filter compositions including an association of flow labels with QoS flows, receiving an Internet Protocol (IP) packet including a flow label, mapping the IP packet to a QoS flow based on the flow label and transmitting the IP packet to a base station.

In a second example, the UPF of the first example, wherein the operations further comprise receiving a further IP packet including the flow label and determining that the IP packet and the further IP packet belong to a same application data unit (ADU) based on the flow label and a time span within which the IP packets were received.

In a third example, the UPF of the first example, wherein the operations further comprise receiving a further IP packet including the flow label and determining that the IP packet and the further IP packet do not belong to a same application data unit (ADU) based on a time span outside of which the IP packets were received.

In a fourth example, a processor of a base station is configured to perform operations comprising receiving a configuration for a QoS profile from a session management function (SMF) for mapping a QoS flow indicator (QFI) to a data radio bearer (DRB), wherein the configuration further includes parameters for determining an application data unit (ADU) for received Internet Protocol (IP) packets, receiving an IP packet including a flow label and determining the ADU for the IP packet, and performing downlink (DL) scheduling for a user equipment (UE) based on the determined ADU.

In a fifth example, the processor of the fourth example, wherein the operations further comprise receiving a further IP packet including the flow label and determining that the IP packet and the further IP packet belong to a same ADU based on the flow label and a time span within which the IP packets were received.

In a sixth example, the processor of the fourth example, wherein the operations further comprise receiving a further IP packet including the flow label and determining that the IP packet and the further IP packet do not belong to a same ADU based on a time span outside of which the IP packets were received.

In a seventh example, a processor of a base station is configured to perform operations comprising receiving an Internet Protocol (IP) packet from a user equipment (UE) including a flow label comprising a plurality of sub-fields, the plurality of sub-fields including an application data unit (ADU) identifier (ID) field for an ADU to which the IP packet belongs, determining the ADU and performing uplink (UL) scheduling for the UE based on information for the ADU.

In an eighth example, the processor of the seventh example, wherein the operations further comprise receiving a configuration for a packet filter from a session management function (SMF) including a flow label field for indicating the flow label.

In a ninth example, the processor of the seventh example, wherein the operations further comprise transmitting the IP packet to a user plane function (UPF), wherein the IP packet is destined for a further UE.

In a tenth example, the processor of the ninth example, wherein the UE and the further UE are accessing an external data network comprising an extended reality (XR) service.

In an eleventh example, the processor of the seventh example, wherein the operations further comprise receiving an ADU status from the UE to enable the base station to perform uplink (UL) scheduling for the UE based on the ADU status.

In a twelfth example, the processor of the eleventh example, wherein the ADU status is reported using uplink control information (UCI) over the physical uplink control channel (PUCCH).

In a thirteenth example, the processor of the twelfth example, wherein the ADU status comprises a remaining packet size and an expiry time for the ADU.

In a fourteenth example, the processor of the twelfth example, wherein a two-part UCI is used wherein a first part of the UCI indicates a number of ADU reports and a second part of the UCI indicates actual ADU reports.

In a fifteenth example, the processor of the eleventh example, wherein the ADU status is reported using a medium access control (MAC) control element (MAC-CE).

In a sixteenth example, the processor of the eleventh example, wherein the ADU status is reported using a PDCP control PDU.

In a seventeenth example, a session management function (SMF) is configured to perform operations comprising configuring a first packet filter for a first flow label, configuring a second packet filter for a second flow label and transmitting the first and second flow labels to a user plane function (UPF).

In an eighteenth example, the SMF of the seventeenth example, wherein the first packet filter comprises a source IP address and a destination IP address for the first flow label.

In a nineteenth example, the SMF of the seventeenth example, wherein the operations further comprise determining and/or receiving one or more packet detection rules (PDR) and configuring the UPF with the one or more packet detection rules.

In a twentieth example, the SMF of the nineteenth example, wherein the operations further comprise receiving one or more policy and charging control (PCC) rules from a policy control function (PCF), wherein the one or more PDR rules are derived from the PCC rules.

In a twenty first example, a session management function (SMF) is configured to perform operations comprising determining a Quality of Service (QOS) profile comprising Qos parameters and QoS characteristics for mapping a QoS flow indicator (QFI) to a dedicated radio bearer (DRB) and configuring a base station with the QoS profile.

In a twenty second example, the SMF of the twenty first example, wherein the operations further comprise configuring the base station with a packet filter comprising a source IP address and a destination IP address for a flow label.

In a twenty third example, a session management function (SMF) is configured to perform operations comprising determining one or more Quality of Service (QOS) rules comprising parameters for processing IP flows and a packet filter and configuring a user equipment (UE) with the Qos rules.

In a twenty fourth example, the SMF of the twenty third example, wherein the operations further comprise configuring the UE base with a packet filter comprising a source IP address and a destination IP address for a flow label.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as iOS, Android, etc. The exemplary embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

1. One or more processors executing a user plane function (UPF) of a core network, the one or more processors configured to:
process an Internet Protocol (IP) packet including a flow label comprising a plurality of sub-fields, the plurality of sub-fields including an application data unit (ADU) identifier (ID) field for an ADU to which the IP packet belongs;
map the IP packet to a quality of service (QOS) flow based on the flow label; and
send the IP packet to a base station with a tag including information from the plurality of sub-fields, the information including an ADU ID.

2. The one or more processors of claim 1, further configured to:
process, based on signals received from a session management function (SMF), a QoS configuration for one or more packet detection rules (PDR), the PDRs comprising one or more packet filter compositions including an association of flow labels with QoS flows.

3. (canceled)

4. The one or more processors of claim 1, wherein the plurality of sub-fields further includes an expiry time field to indicate a time duration to wait to receive all packets of the ADU prior to discarding packets of the ADU already received.

5-6. (canceled)

7. The one or more processors of claim 1, wherein the plurality of sub-fields further includes a priority field to indicate a type of media in the IP packet, wherein the priority field indicates whether an I-slice or a P-slice generated by a video compression standard is in the IP packet.

8. (canceled)

9. The one or more processors of claim 1, wherein the plurality of sub-fields further includes a policy field indicating a policy for treatment of bits within the ADU.

10. The one or more processors of claim 1, wherein the IP packet is received from one of an external data network or another UPF, wherein the external data network comprises an extended reality (XR) service.

11-12. (canceled)

13. A processor configured to:
process an Internet Protocol (IP) packet including a tag indicating information, the information including an application data unit (ADU) Identification (ID) for an ADU to which the IP packet belongs;
extract the information indicated in the tag; and
perform downlink (DL) scheduling for a user equipment (UE) based on the information extracted from the tag.

14. The processor of claim 13, further configured to:
process, based on signals received from a session management function (SMF), a configuration for a QoS profile to map a QoS flow indicator (QFI) to a data radio bearer (DRB), wherein the configuration further includes parameters for extraction of the information from the tag.

15. The processor of claim 13, wherein the information is included in an N3 encapsulation header.

16-24. (canceled)

25. A processor configured to:
generate an Internet Protocol (IP) packet including a flow label comprising a plurality of sub-fields, the plurality of sub-fields including an application data unit (ADU) identifier (ID) field for an ADU to which the IP packet belongs; and
prepare, for transmission to a base station, the IP packet with the flow label.

26. The processor of claim 25, further configured to:
process, based on signals received from the base station, a configuration for a packet filter from a session management function (SMF) including a flow label field to indicate the flow label.

27. The processor of claim 25, wherein the IP packet is destined for a user equipment (UE), wherein the processor and the UE are accessing an external data network comprising an extended reality (XR) service.

28. (canceled)

29. The processor of claim 27, wherein the plurality of sub-fields further includes an expiry time field to indicate a time duration to wait to receive all packets of the ADU prior to discarding packets of the ADU already received.

30. The processor of claim 29, wherein the plurality of sub-fields further includes a remaining packet size field to indicate a number of bytes remaining for transmission for the ADU.

31. The processor of claim 30, wherein an expiry time from the expiry time field and a remaining packet size from the remaining packet size field are mapped to fields in an N3 encapsulation header for transmission to a further base station serving the UE.

32. The processor of claim 25, wherein the plurality of sub-fields further includes a priority field to indicate a type of media in the IP packet, wherein the priority field indicates whether an I-slice or a P-slice generated by a video compression standard is in the IP packet.

33. (canceled)

34. The processor of claim 25, wherein the plurality of sub-fields further includes a policy field indicating a policy for treatment of bits within the ADU.

35. The processor of claim 25, further configured to:
generate, for transmission to the base station, an ADU status, wherein the ADU status is reported using uplink control information (UCI) over a physical uplink control channel (PUCCH).

36. (canceled)

37. The processor of claim 35, wherein the ADU status comprises a remaining packet size and an expiry time for the ADU.

38. The processor of claim 35, wherein a two-part UCI is used wherein a first part of the UCI indicates a number of ADU reports and a second part of the UCI indicates actual ADU reports.

39-40. (canceled)
